(19) United States
(12) Patent Application Publication
(10) Pub. No.: US 2010/0240366 A1
(43) Pub. Date: Sep. 23, 2010

(54) CONNECTION ATTEMPT MESSAGE PROCEDURE ENHANCEMENT FOR MANUAL SELECTION OF A HYBRID HOME NETWORK BASE STATION

(75) Inventors: Hao Bi, Lake Zurich, IL (US); Scott Droste, Crystal Lake, IL (US); Jian Wu, Reading (GB)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/408,959

(22) Filed: Mar. 23, 2009

(51) Int. Cl. H04W 4/00

(52) U.S. Cl. 455/435.1

(57) ABSTRACT

A method, a mobile system, and a home network base station are disclosed. A processor 304 may append an access request value 540 to a connection attempt message 500 to indicate an access protocol goal. A transceiver 302 may send the connection attempt message 500 to the home network base station.

### FIELD OF THE INVENTION

The present invention relates to a method and system for accessing a home network. The present invention further relates to appending an access request value to a connection attempt message to indicate an access protocol goal.

### INTRODUCTION

A mobile system may access a universal terrestrial radio access network (UTRAN) and an evolved UTRAN (E-UTRAN) cellular network through base stations installed at domestic home or belonging to business and commercial enterprises, called Home NodeB (HNB) in UTRAN and Home eNodeB (HeNB) in E-UTRAN. The HNB or the HeNB may be part of an at least partially wireless local area network (LAN) referred to as a home network.

The access to a HNB and a HeNB may be controlled through a closed subscriber group (CSG) membership. Each HNB and HeNB may be associated with a particular CSG, such that a mobile user with a valid membership to that CSG may gain access. An allowed CSG identifier (ID) list may contain the information of which CSG the mobile user has access or a subscription. The CSG ID list may be used by a mobile or a network to control access to the HeNB.

### SUMMARY OF THE INVENTION

A method, a mobile system, and a home network base station are disclosed. A processor may append an access request value to a connection attempt message to indicate an access protocol goal. A transceiver may send the connection attempt message to the home network base station.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a communication system.

FIG. 2 illustrates a possible configuration of a computing system to act as a base transceiver station.

FIG. 3 illustrates in a block diagram one embodiment of a mobile system or electronic device to create a radio connection.

FIG. 4 illustrates, in a block diagram, one embodiment of an architectural layout of a home network base station.

FIG. 5 illustrates, in a block diagram, one embodiment of a connection attempt message.

FIG. 6 illustrates, in a block diagram, one embodiment of a connection response message.

FIG. 7 illustrates, in a flowchart, one embodiment of a method of accessing a home network base station.

FIG. 8 illustrates, in a flowchart, one embodiment of a method of receiving an access attempt from a mobile system.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, a mobile system, and a home network base station are disclosed. A processor may append an access request value to a connection attempt message to indicate an access protocol goal. A transceiver may send the connection attempt message to the home network base station.

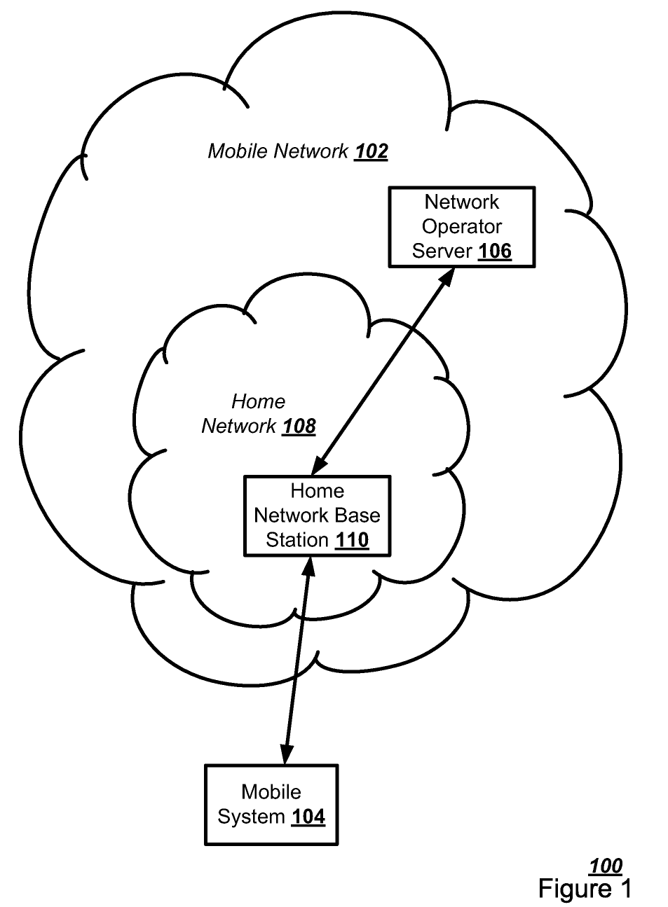

FIG. 1 illustrates one embodiment of a communication system 100. The communication system 100 may include a mobile network 102 that may be accessed by at least one mobile device 104, such as an electronic device or mobile system. Various communication devices may exchange data or information through the mobile network 102. The mobile network 102 may be a WiMAX network, a universal terrestrial radio access network (UTRAN) cellular network, an evolved UTRAN (E-UTRAN) cellular network, or other type of telecommunication network. A server or a series of servers controlled by a network operator, referred to herein as a network operator server 106, may administer the network. The network operator server 106 may maintain a set of data to facilitate access of the mobile network 102 by a mobile system 104.

A home, office, or other localized setting may maintain a home network 108. The home network 108 may be an at least partially wireless local area network (LAN) connected to the mobile network 102. The home network 108 may be connected to the mobile network 102 via one or more home network base station 110, such as a home NodeB (HNB) or a home evolved NodeB (HeNB). The mobile system 104 may use the home network base station 110 to access either the mobile network 102 or the home network 108. The home network 108 may allow a mobile system 102 access, if the mobile system 102 is a part of a closed subscriber group (CSG) associated with the home network 108. The mobile system 104 may store a list of CSG identifiers (ID), or a CSG ID list, detailing which home networks 108 the mobile system 104 may access. The network operator server 106 may store the CSG ID list to administer access to the various home networks.

If the home network base station 110 is a closed base station, a mobile system 104 may connect with the home network base station 110 if the mobile system 104 is a member of the associated CSG. If the home network base station 110 is a hybrid base station or open base station, a mobile system 104 may use the home network base station 110 to connect with the mobile network 102 even if the mobile system 104 is not a member of the associated CSG.

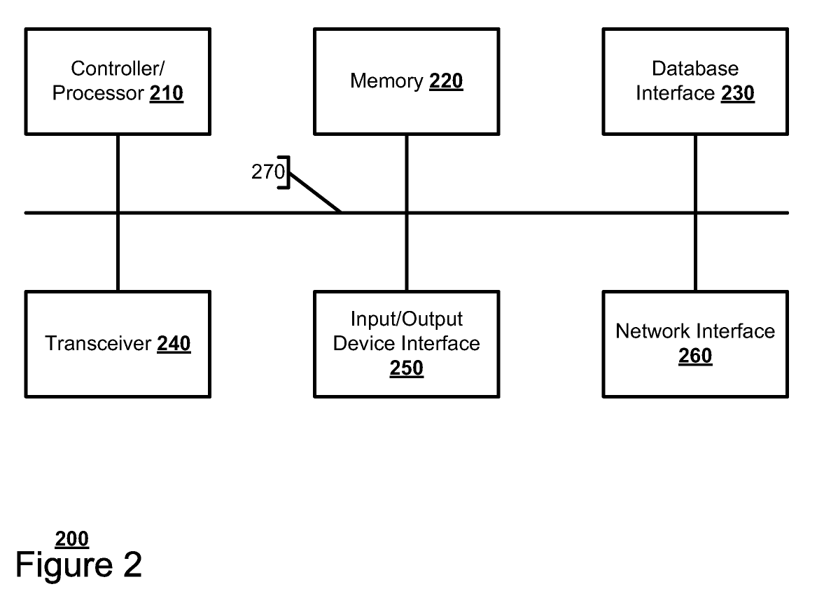

FIG. 2 illustrates a possible configuration of a computing system 200 to act as a network operator server 106 or a home network base station 110. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein may be used to implement the decision support system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc-read only memory (CD-ROM, digital video disc-read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain a subscriber information set for each mobile system that may access the mobile network 102 or a home network 108.

The transceiver 240 may create a connection with the mobile device 104. The transceiver 240 may be incorporated into the base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The network connection interface 260 may be used to connect the teleconference device to the network connecting the user to other users in the teleconference. The components of the network server 200 may be connected via an electrical bus 270, for example, or linked wirelessly.

Client software and databases may be accessed by the controller/processor 210 from memory 220, and may include, for example, database applications, word processing applications, as well as components that embody the decision support functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

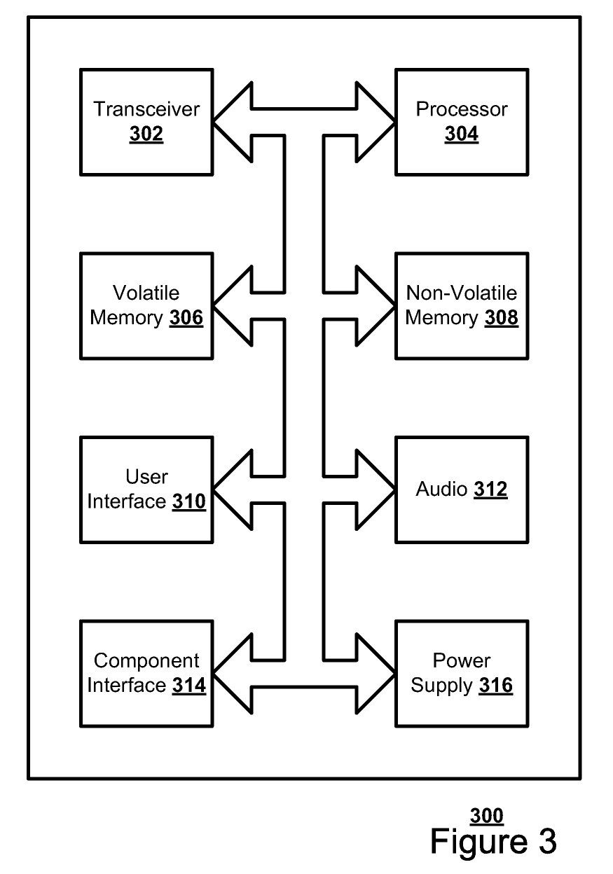

FIG. 3 illustrates one embodiment of a mobile device 300, capable of acting as a mobile system or electronic device. For some embodiments of the present invention, the mobile device 300 may also support one or more applications for performing various communications with a network. The mobile device 300 may be a handheld device, such as, a mobile phone, a laptop, or a personal digital assistant PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 to act as data storage for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface. Finally, the mobile device 300 may include a power supply 316.

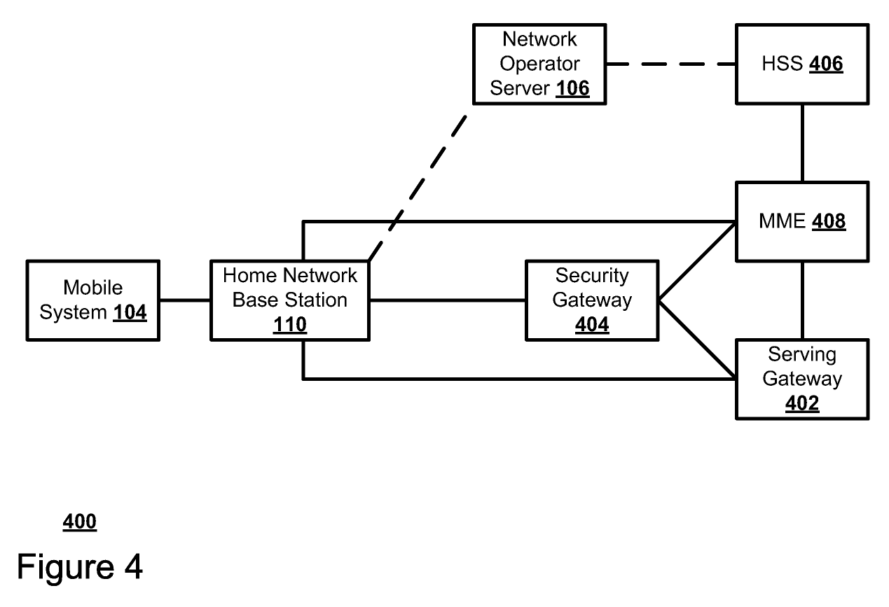

FIG. 4 illustrates, in a block diagram, one embodiment of an architectural layout 400 of a home network base station 110. A mobile system 104 may access a network operator server 106, or CSG server 106, via the home network base station 110. The home network base station 110 may use a serving gateway 402 to create a data communications link between the mobile system 104 and the mobile network 102 once a connection has been established. The home network base station 110 may use a security gateway 404 to establish a secure connection with the mobile network 102. The CSG server 106 may use these connections to establish the level of trust between the mobile system 104 and the home network 108.

The network operator server 106 may store and configure a CSG ID list for each mobile system 106, listing the ID of CSGs the mobile may subscribe to. The CSG ID list may be used by a home subscriber service (HSS) 406, for the mobile system 104, and a mobility management entity (MME) 408, for the mobile network 102, to control mobile access to a CSG cell. A mobile user may trigger the updating of CSG ID list using manual selection. A user may request the mobile system 104 to perform a scan of nearby home network base stations 110. The mobile system 104 may display the CSG identities and names of the found home network base stations 110, indicating which CSG IDs are on the CSG ID list. When the user selects a home network base station 110 with a CSG ID not on the CSG ID list, the mobile system 104 may try to access the mobile network 102 through a connection attempt message, such as an “attach” message, tracking area update (TAU) message, service request message, or other messages attempting to connect to the mobile network 102. Upon making a decision, the home network base station 110 may send a connection response message. If the home network base station 110 grants access, the mobile system 104 may receive an “Attach Accept” or a “TAU Accept” message. The mobile system 104 may add the associated CSG ID to the mobile CSG ID list, if not already included. The mobile system 104 may add the CSG ID to the user's CSG ID list, if not already included. If the home network base station 110 rejects access, the mobile system 104 may receive an “Attach Reject” or a “TAU Reject” message. The mobile system 104 may remove the associated CSG ID from the mobile CSG ID list if present. The mobile system 104 may remove the CSG ID from the user's CSG ID list if present.

If the home network base station 110 is in closed mode, using “Attach” message or a TAU message may not cause ambiguities on the mobile system 104 and the mobile network 102 as to whether the CSG ID of the home network base station 110 may be added to the CSG ID list. If the CSG ID is not on the CSG ID list, the mobile system 104 may send out an “Attach” request or a TAU Request just for manual selection. If the CSG ID is on the CSG ID list, a reject message, with a specific indication that the mobile system 104 may not access the home network base station 110, may remove the CSG ID from the CSG ID list.

When a home network base station 110 is configured for hybrid access mode, the home network base station 110 may provide services to associated CSG members or subscribers of any public land mobile network (PLMN) not belonging to an associated CSG, subject to a roaming agreement. After receiving an “Attach” message or a TAU message, the MME 408 may be confused as to whether the mobile system is attaching using an open provision of the hybrid home network base station 110 or using manual selection of the CSG.

Hence, the MME 408 may not know whether to perform a normal attachment procedure or a manual selection procedure, leading to a misunderstanding between the mobile system 104 and the MME 408 and a mismatch of the CSG ID list on the mobile system 104 and home network 108. The user may want to perform a manual selection, sending out the appropriate “Attach” message or TAU request. However, the MME 408 may treat the connection attempt message as a regular connection attempt message from the open provision of the hybrid home network base station 110. The MME 408 may not select the CSG and not have the CSG ID on the CSG ID List in the MME 408. However, the acceptance of the connection attempt message may make the mobile system 104 select this CSG, with the CSG ID included in the CSG ID list on the mobile system 104.

Alternately, the mobile system 104 may perform a normal connection attempt procedure, but the MME 408 may think the user wants to do a manual selection of the CSG cell. So the MME 408 may grant access to the CSG without user's request or awareness. The MME 408 may include the CSG ID on the CSG ID List on the MME 408. The CSG ID may not be on the CSG ID List on the mobile system 104.

To alleviate this, the mobile system 104 may add an access request value to the connection attempt message to indicate an access protocol goal, such as whether the user desires to manually select the CSG to subscribe to the CSG or just attach to the network 102. An accepting connection response message may acknowledge the success of the corresponding procedure, while a rejecting connection response message may alert the mobile system 104 to the failure of the corresponding procedure. If the access request value is set to a network access value, the MME 408 may perform a normal connection attempt procedure, leaving the user's CSG subscription status unchanged. If the access request value is set to a subscription request value, the MME 408 may check if the user may be added as a CSG member. If so, the MME 408 may send an accepting connection response message and see to the addition of the CSG ID to the CSG ID list of the mobile system 104. If not, the MME 408 may send a rejecting connection response message and see to the removal of the CSG ID from the CSG ID list of the mobile system 104. If the access request value is set to a combination request value, the MME 408 may create a normal network connection while performing the subscription procedure.

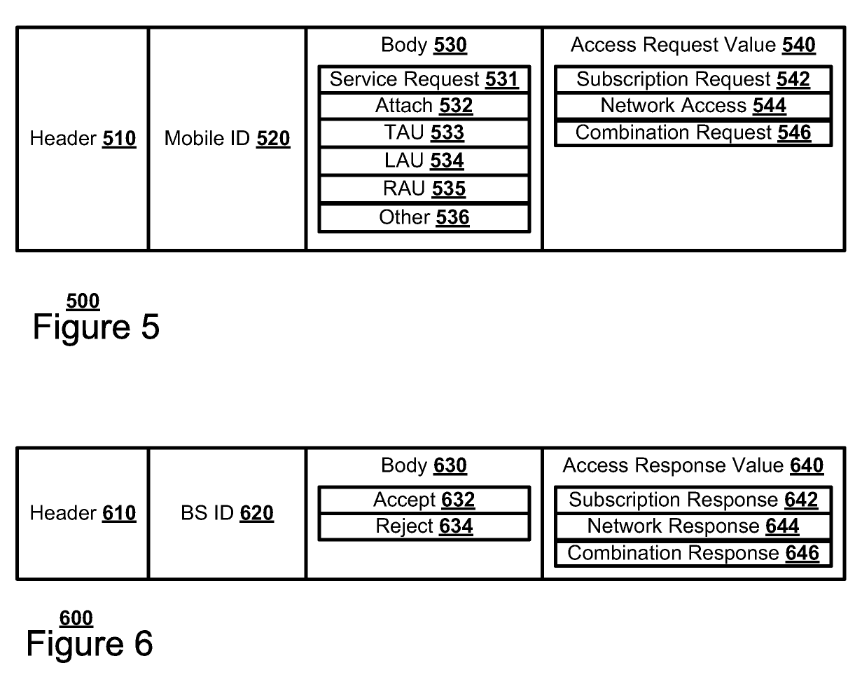

FIG. 5 illustrates, in a block diagram, one embodiment of a connection attempt message 500. The connection attempt message 500 may have a header 510 to direct the path of the connection attempt message 500 to the home network base station 110. The connection attempt message 500 may have the mobile ID 520 of the mobile system 104 that sends the connection attempt message 500. The body 530 of the connection attempt message 500 may contain data explaining the action to be taken by the home network base station 110. The body 530 may have a service request message 531, an attach message 532, a tracking area update (TAU) message 533, a location area update (LAU) message 534, a routing area update (RAU) message 535, or other connection messages 536. The mobile system 104 may append an access request value 540 to the connection attempt message 500 to indicate an access protocol goal, such as subscribing to the closed subscription group or connecting to the network. The access request value 540 may be a subscription request value 542 to indicate a closed subscriber group access, or an attempt to subscribe to a closed subscription group. The access request value 540 may be a network access value 544 to indicate a general network access, or an attempt to connect to the network or to update the position of the mobile system 104 in the mobile network 102. The access request value 540 may be a combination request value 546 to indicate a combination of the closed subscriber group access and the general network access.

FIG. 6 illustrates, in a block diagram, one embodiment of a connection response message 600. The connection response message 600 may have a header 610 to direct the path of the connection response message 600 to the mobile system 104. The connection response message 600 may have the base station (BS) ID 620 of the home network base station 110 that sends the connection response message 600. The body 630 of the connection response message 600 may contain data confirming the action being taken by the home network base station 110, either as an “Accept” message 632 or a “Reject” message 634. The home network base station 110 may append an access response value 640 to the connection response message 600 to indicate acceptance of an access protocol goal, such as subscribing to the closed subscription group or connecting to the network. The access response value 640 may be a subscription response value 642 to confirm that the home network base station is performing a closed subscriber group access. The access response value 640 may be a network access value 644 to confirm that the home network base station is performing a general network access. The access response value 640 may be a combination response value 646 to confirm that the home network base station is performing a combination of the closed subscriber group access or the general network access.

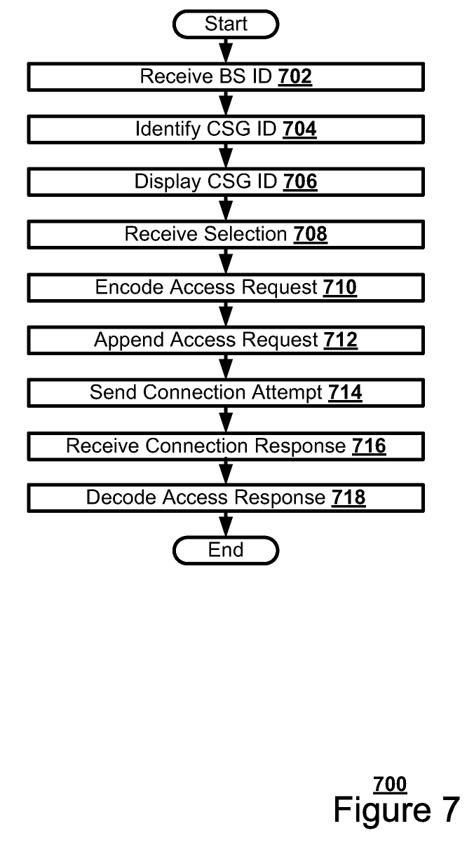

FIG. 7 illustrates, in a flowchart, one embodiment of a method 700 of accessing a home network base station. The mobile system 104 may receive a BS ID 620 from the home network base station 110 (Block 702). The mobile system 104 may identify the CSG ID from the BS ID 620 (Block 704). The mobile system 104 may display the CSG ID to the user using the user interface 310 (Block 706). The mobile system 104 may receive an option selection from the user (Block 708). The option selection may indicate which CSG ID the user selected. Further, the option selection may indicate whether the user wishes to subscribe to the CSG, use the home network base station 110 to connect to the mobile network 102, or connect to the mobile network 102 while beginning the subscription process. The mobile system 104 may encode an access request value 540 based upon the option selection (Block 710). The mobile system 104 may append the access request value 540 to a connection attempt message 500 (Block 712), then send the connection attempt message 500 to the home network base station 110 (Block 714). The mobile system 104 may receive a connection response message 600 confirming receipt of the connection attempt message 500 (Block 716). The mobile system 104 may decode the access response value 640 of the connection response message 600 to determine that the proper action is being performed Block 718).

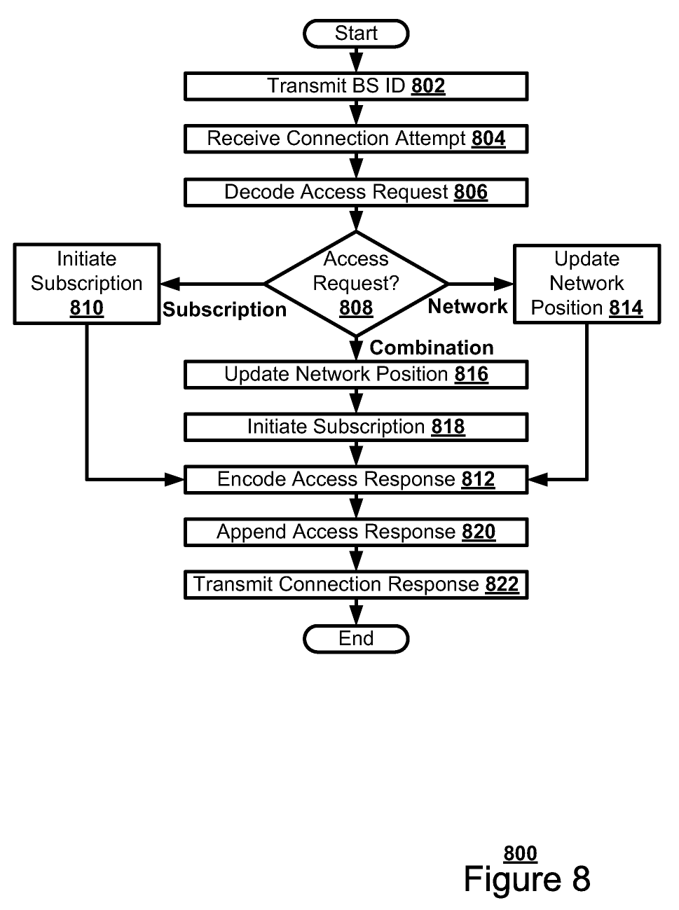

FIG. 8 illustrates, in a flowchart, one embodiment of a method 800 of receiving an access attempt from a mobile system. The home network base station 110 may transmit a BS ID 620, allowing mobile systems 104 in the area to identify the home network base station 110 (Block 802). The home network base station 110 may receive a connection attempt message 500 from a mobile system 104 (Block 804). The home network base station 110 may pass the message to the MME 408. The MME 408 may decode the access request value 540 appended to the connection attempt message 500 Block 806). If the access request value 540 is a subscription request value 542 (Block 808), the MME 408 may initiate subscription of the mobile system 104 with the CSG Block 810). The MME 408 may encode an access response value 640 with a subscription response value 642 (Block 812). If the access request value 540 is a network access value 544 (Block 808), the MME 408 may update the network position of the mobile system 104 with the mobile network 102 (Block 814). The MME 408 may encode an access response value 640 with a network response value 644 (Block 812). If the access request value 540 is a combination request value 546 Block 808), the MME 408 may update the network position of the mobile system 104 with the mobile network 102 Block 816). The MME 408 may initiate subscription of the mobile system 104 with the CSG (Block 818). The MME 408 may encode an access response value 640 with a combination response value 646 Block 812). The MME 408 may append the access response value 640 to the connection response message 600 Block 820), and transmit the connection response message 600 to the mobile system 104 via the home network base station 110 (Block 822).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for accessing a home network base station, comprising:
appending an access request value to a connection attempt message to indicate an access protocol goal; and
sending the connection attempt message to the home network base station.

2. The method of claim 1, wherein the access request value is at least one of a subscription request value to indicate a closed subscriber group access, a network access value to indicate a general network access, and a combination request value to indicate a combination of the closed subscriber group access and the general network access.

3. The method of claim 1, further comprising:
receiving an option selection from a user.

4. The method of claim 1, wherein the connection attempt message is a tracking area update message, service request message, or an attach message.

5. The method of claim 1, further comprising:
receiving a connection response message from the home network base station.

6. The method of claim 5, further comprising:
decoding an access response value appended to the connection response message to indicate the access protocol goal.

7. The method of claim 6, wherein the access response value is at least one of a subscription response value to confirm a closed subscriber group access, a network response value to confirm a general network access, and a combination response value to confirm a combination of the closed subscriber group access and the general network access.

8. A mobile system for accessing to a home network base station, comprising:
a processor that appends an access request value to a connection attempt message to indicate an access protocol goal; and
a transceiver that sends the connection attempt message to the home network base station.

9. The mobile system of claim 8, wherein the access request value is at least one of a subscription request value to indicate a closed subscriber group access, a network access value to indicate a general network access, and a combination request value to indicate a combination of the closed subscriber group access and the general network access.

10. The mobile system of claim 8, further comprising:
a user interface that receives an option selection from a user.

11. The mobile system of claim 8, wherein the connection attempt message is a tracking area update message, service request message, or an attach message.

12. The mobile system of claim 8, wherein the transceiver receives a connection response message from the home network base station.

13. The mobile system of claim 12, wherein the processer decodes an access response value appended to the connection response message to indicate the access protocol goal.

14. A home network base station that connects to a mobile system, comprising:
a transceiver that receives a connection attempt message from the mobile system;
a processor that decodes an access request value appended to the connection attempt message and creates a communication connection with the mobile system based upon an access protocol goal indicated by the access request value.

15. The home network base station of claim 14, wherein the access request value is at least one of a subscription request value to indicate a closed subscriber group access, a network access value to indicate a general network access, and a combination request value to indicate a combination of the closed subscriber group access and the general network access.

16. The home network base station of claim 14, further comprising:
a network interface that updates a network position upon the processor decoding the access request value as a network access value.

17. The home network base station of claim 14, further comprising:
a network interface that initiates subscription of the mobile system to a closed subscription group upon the processor decoding the access request value as a subscription request value.

18. The home network base station of claim 14, further comprising:
a network interface that updates a network position and initiates subscription of the mobile system to a closed subscription group upon the processor decoding the access request value as a combination request value.

19. The home network base station of claim 14, wherein the processor appends an access response value to a connection response message to indicate acceptance of the access protocol goal and the transceiver transmits the connection response message to the mobile system.

20. The home network base station of claim 19, wherein the access response value is at least one of a subscription response value to confirm a closed subscriber group access, a network response value to confirm a general network access, and a combination response value to confirm a combination of the closed subscriber group access and the general network access.
